(19) United States
(12) Patent Application Publication
(10) Pub. No.: US 2008/0223235 A1
(43) Pub. Date: Sep. 18, 2008

(54) INK LINER FRAME FOR PAD PRINTING AND DECORATING

(76) Inventor: Christopher Schaafsma, Wheaton, IL (US)

Correspondence Address: CARDINAL LAW GROUP, Suite 2000, 1603 Orrington Avenue, Evanston, IL, 60201, US

(21) Appl. No.: 12/013,888

(22) Filed: Jan. 14, 2008

Related U.S. Application Data
(60) Provisional application No. 60/894,826, filed on Mar. 14, 2007.

(51) Int. Cl. B41F 9/10

(52) U.S. Cl. 101/169; 101/170

(57) ABSTRACT

A pad printing system includes a doctor blade and an ink liner frame removably attached to the doctor blade. The ink liner frame is removably attachable to an ink liner. A pad printing system includes a doctor blade, an ink liner, and an ink liner frame removably attached to the doctor blade, wherein the ink liner frame is removably attachable to the ink liner.

### RELATED APPLICATIONS

This application claims the benefit of, and priority to, U.S. Provisional Patent Application 60/894,826 filed Mar. 14, 2007. The entirety of that application is hereby incorporated by reference.

### BACKGROUND OF THE INVENTION

The present invention relates to liquid supply assemblies for printers. More particularly, the present invention relates to a disposable cup insert as a temporary reservoir designed to hold a liquid (e.g., a liquid mixture of ink and thinner) used in a pad printing and decorating process.

Automated printing systems are in widespread use in a host of industries. And, the number of types of printing systems is almost as great as the number of industries in which these systems are used.

One type of printing system that operates in a fully automatic or near fully automatic mode is a pad printing system. These systems are used to apply high quality print (e.g., indicia) on flat as well as non-flat surfaces. For example, pad printing systems can be used to print logos and the like on cellular telephone covers, game balls (e.g., golf balls) and the like. It will be appreciated that such printing must be carried out, not only on a spherical surface, but on a surface that is formed with dimples as well.

Conventional pad printing systems use a deformable pad which receives ink, transferred as an image, from a flat cliché plate. The plate has an engraving or etching of the indicia formed therein. Ink is transferred from a liquid supply assembly to the cliché plate, and fills into the etched areas. The deformable pad is then pressed onto the plate and ink within the liquid is picked up by the pad. The image is then transferred to the curved surface which is to be printed.

To re-ink the pad, in a commonly used arrangement, an inverted cup containing a quantity of printing ink is used to apply the ink to the cliché plate. To apply a new coating of ink to the cliché plate, the cup and cliché plate are moved relative to each other following each ink transfer operation. A doctor blade is fitted to the cup to traverse along the cliché plate and “wipe” excess ink from the cliché plate. This assures that ink is left behind in the etching but does not build up on the plate, inside or outside of the etched areas.

Currently, the cup is typically cleaned after each use of the cup in applying a new coating of ink to the cliché plate. Such cleaning can be costly in terms of time, labor and materials. Accordingly, there is a need for a liquid supply assembly for a printing system that minimizes, if not eliminates, a cleaning requirement of the reusable cup after each of use of the cup in applying a new coating of ink to the cliché plate.

### SUMMARY OF THE INVENTION

The present invention provides a pad printing system that includes a doctor blade and an ink liner frame removably attached to the doctor blade. The ink liner frame is removably attachable to an ink liner.

Another aspect of the invention provides a pad printing system that includes a doctor blade, an ink liner, and an ink liner frame removably attached to the doctor blade, wherein the ink liner frame is removably attachable to the ink liner.

Yet another aspect of the invention provides a method of operating a pad printing system. The method includes positioning an ink liner frame in contact with an ink liner and attaching the positioned ink liner frame and ink liner to a doctor blade.

These and other features and advantages of the present invention will be readily apparent from the following detailed description, in conjunction with the claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 illustrates a side view of one embodiment of a liquid supply assembly in accordance with the present invention as employed in a pad printing system further employing a printing pad and a cliché plate as known in the art;

FIG. 2 illustrates an exploded side view of the liquid supply assembly illustrated in FIG. 1 in accordance with the present invention;

FIG. 3 illustrates a cross-sectional view of the liquid supply assembly illustrated in FIG. 1 in accordance with the present invention;

FIG. 4 illustrates a partial cross-sectional view of a first embodiment of a sealing configuration of the liquid supply assembly illustrated in FIGS. 2 and 3 in accordance with the present invention;

FIG. 5 illustrates a partial cross-sectional view of a second embodiment of a sealing configuration of the liquid supply assembly illustrated in FIGS. 2 and 3 in accordance with the present invention;

FIG. 6 illustrates a partial cross-sectional view of a third embodiment of a sealing configuration of the liquid supply assembly illustrated in FIGS. 2 and 3 in accordance with the present invention;

FIG. 7 illustrates a partial cross-sectional view of a fourth embodiment of a sealing configuration of the liquid supply assembly illustrated in FIGS. 2 and 3 in accordance with the present invention;

FIG. 8 illustrates a partial cross-sectional view of a fifth embodiment of a sealing configuration of the liquid supply assembly illustrated in FIGS. 2 and 3 in accordance with the present invention;

FIG. 9 illustrates a partial cross-sectional view of a sixth embodiment of a sealing configuration of the liquid supply assembly illustrated in FIGS. 2 and 3 in accordance with the present invention;

FIG. 10 illustrates an exemplary use of a pair of disposable cup inserts in accordance with the present invention;

FIG. 11 illustrates a partial cross-sectional view of another embodiment of a sealing configuration of the liquid supply assembly illustrated in FIGS. 2 and 3 in accordance with the present invention;

FIG. 12 illustrates a side view of one embodiment of a liquid supply assembly in accordance with the present invention;

FIG. 13 illustrates a top view of an ink liner frame in accordance with one aspect of the invention;

FIG. 14 illustrates a side view of an ink liner frame in accordance with one aspect of the invention;

FIG. 15 illustrates a top view of an ink liner frame in accordance with one aspect of the invention;

FIG. 16A illustrates a side view of an ink liner frame in accordance with one aspect of the invention

FIG. 16B illustrates a perspective view of an ink liner frame with an ink liner positioned in the ink liner frame and a doctor blade positioned in the ink liner in accordance with one aspect of the invention;

FIG. 16C illustrates a perspective view of several frames similar to that of FIG. 16B with the ink liners slightly disengaged from the ink liner frames;

FIG. 16D illustrates an ink liner frame with an ink liner disposed upon a printing surface; and

FIG. 17 illustrates a flowchart of a method for operating a pad printing system in accordance with one aspect of the invention.

### DETAILED DESCRIPTION OF THE INVENTION

While the present invention is susceptible of embodiment in various forms, there is shown in the drawings and will hereinafter be described as presently preferred embodiments with the understanding that the presently preferred embodiments are to be considered an exemplification of the present invention and are not intended to limit the present invention to the specific embodiments illustrated.

It should be understood that the title of this section of this specification, namely, “Detailed Description of the Invention”, relates to a requirement of the United States Patent Office, and does not imply, nor should be inferred to limit the subject matter disclosed herein.

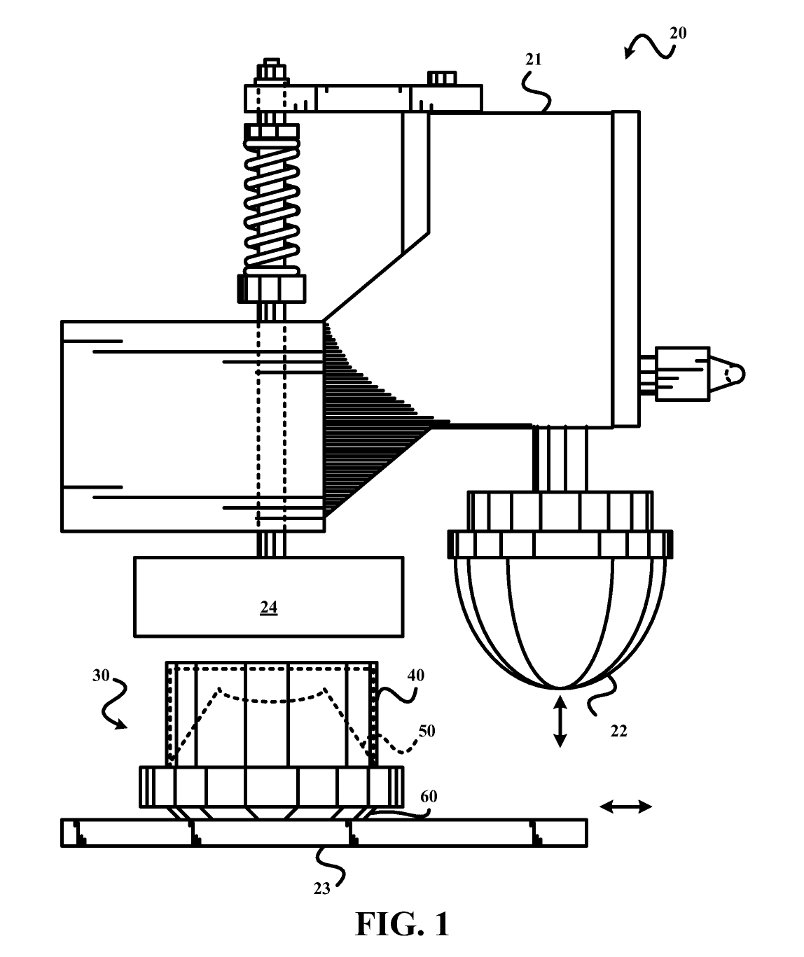

Referring now to the drawings, FIG. 1 illustrates a portion of an exemplary pad printer 20 including a frame having a reciprocating printing pad 22 mounted thereto. Printing pad 22 is a deformable pad onto which ink is transferred, and from which the ink is further transferred to the object to be imprinted. A typical printing pad 22 is formed from a resilient, low permeability material such as silicone rubber or the like.

Also shown are a cliché plate 23, which has the artwork in the form of an engraving or etching, and a liquid supply assembly 30, which is secured by a cup gripping mechanism (“CGM”) 24 of pad printer 20 whereby cliché plate 23 and liquid supply assembly 30 can be reciprocated relative to one another to supply a liquid held by the liquid supply assembly 30 to cliché plate 23 (e.g., ink from an ink/thinner liquid mixture). To this end, liquid supply assembly 30 includes a reusable cup 40, a disposable cup insert 50 inserted within reusable cup 40, and a scraping element in the form of a doctor blade 60. In operation, cup gripping mechanism 24 secures reusable cup 40 as would be appreciated by those having ordinary skill in the art whereby, as the liquid supply assembly 30 and/or cliché plate 23 are being translated in a horizontal direction, liquid held by disposable cup insert 50 can be deposited in a receiving region on cliché plate 23 and any excess of the liquid can be scraped from cliché plate 23 by doctor blade 60 to thereby leave liquid in the receiving region only of cliché plate 23.

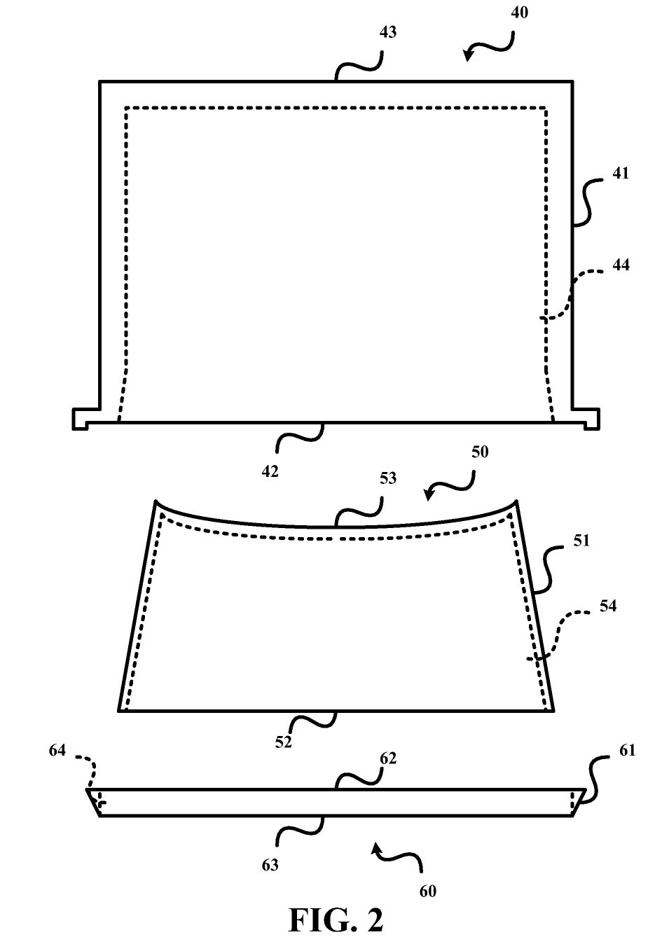

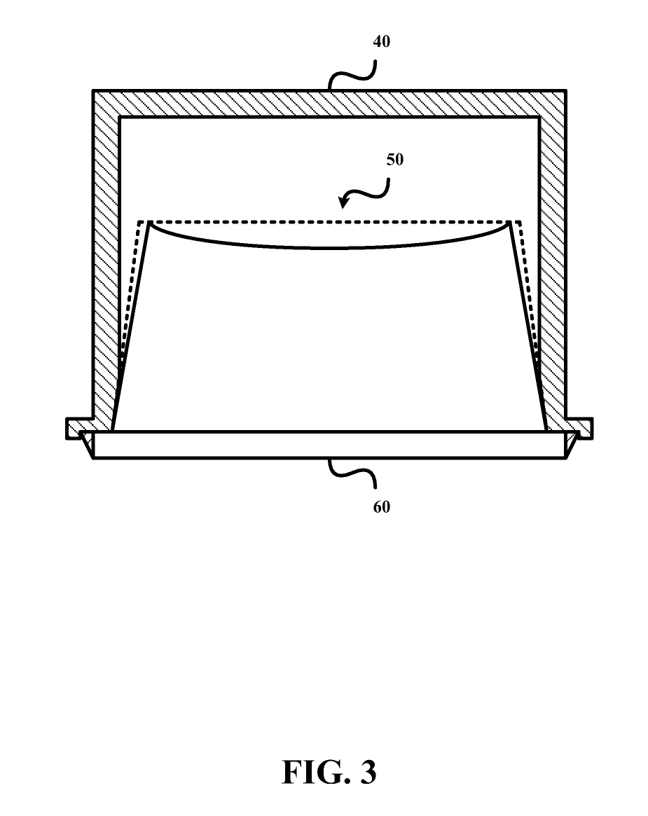

FIG. 2 illustrates an unassembled view of liquid supply assembly 40 and FIG. 3 illustrates an assembled view of liquid supply assembly 40 as placed on doctor blade 63. As shown in FIG. 2, reusable cup 40 includes a hollow reservoir body 41 having an open flanged outlet 42 and a closed base 43 defining a reusable liquid reservoir 44. As shown in FIG. 2, reusable liquid reservoir 44 has a size and shape for receiving disposable cup insert 50 therein.

As shown in FIG. 2, disposable cup insert 50 includes a hollow reservoir body 51 having an open flanged outlet 52 and a closed base 53 defining a temporary liquid reservoir 54 for holding a liquid within reusable liquid reservoir 54 (e.g., an ink/thinner mixture), and doctor blade 60 includes a hollow doctor blade 61 having an open inlet 62 and an open outlet 63 defining a conduit 64. As shown in FIG. 2, reservoir 54 and conduit 64 are sized and shaped to facilitate a flow of liquid held by liquid reservoir 54 through conduit 64 when disposable cup insert 50 and doctor blade 60 are physically aligned.

Referring to FIG. 3, reusable cup 40, disposable cup insert 50 and doctor blade 60 can have any material composition suitable for holding and supplying liquid (e.g., ink) to cliché plate 20 (FIG. 2) as would be appreciated by those having ordinary skill in the art. In one embodiment, closed base 53 (FIG. 2) of disposable cup insert 50 has a flexible material composition (e.g., deformable plastic that is recyclable) that facilitates an expansion of liquid reservoir 54 (FIG. 2) as indicated by the dashed outline of disposable cup insert 50 in response to an increase in a gas pressure exerted by the liquid on liquid reservoir 54 (FIG. 2), such as, for example, an increase in the gas pressure by an ink/thinner liquid mixture on liquid reservoir 54 (FIG. 2) in view of an evaporation of the thinner from the ink/thinner liquid mixture held by liquid reservoir 54 (FIG. 2). In this embodiment, other portions of hollow reservoir body 51 (FIG. 2), such as open flanged outlet 52 (FIG. 2), can also have a flexible material composition.

Referring to FIG. 2, those having ordinary skill in the art will appreciate the need to provide a seal between the open flanged outlet 42 of reusable cup 40, open flanged outlet 52 of disposable cup insert 50 and doctor blade 60 to thereby prevent any side leakage of the liquid held by temporary reservoir 54. The present invention does not impose any limitations or any restrictions as to the structural configurations of open flanged outlet 42 of reusable cup 40 and open flanged outlet 52 of disposable cup insert 50 for purposing of facilitating such a seal. Thus, the following exemplary embodiments of a sealing configuration does not limit nor restrict the scope of structural configurations of open flanged outlet 42 of reusable cup 40 and open flanged outlet 52 of disposable cup insert 50 for purposing of facilitating a seal between the open flanged outlet 42 of reusable cup 40, open flanged outlet 52 of disposable cup insert 50 and doctor blade 60.

In a first sealing configuration embodiment, as shown in FIG. 4, the flange of open outlet 42 (see FIG. 2) is in the form of a seat 45 and the flange of open outlet 54 is in the form of a seat 55. As assembled, seat 45 supports seat 55, which in turn supports doctor blade 61 to thereby physically align liquid reservoir 54 with conduit 64. In this embodiment, a seal between seat 45 and doctor blade 61 is formed by a press-fit technique as would be appreciated by those having ordinary skill in the art.

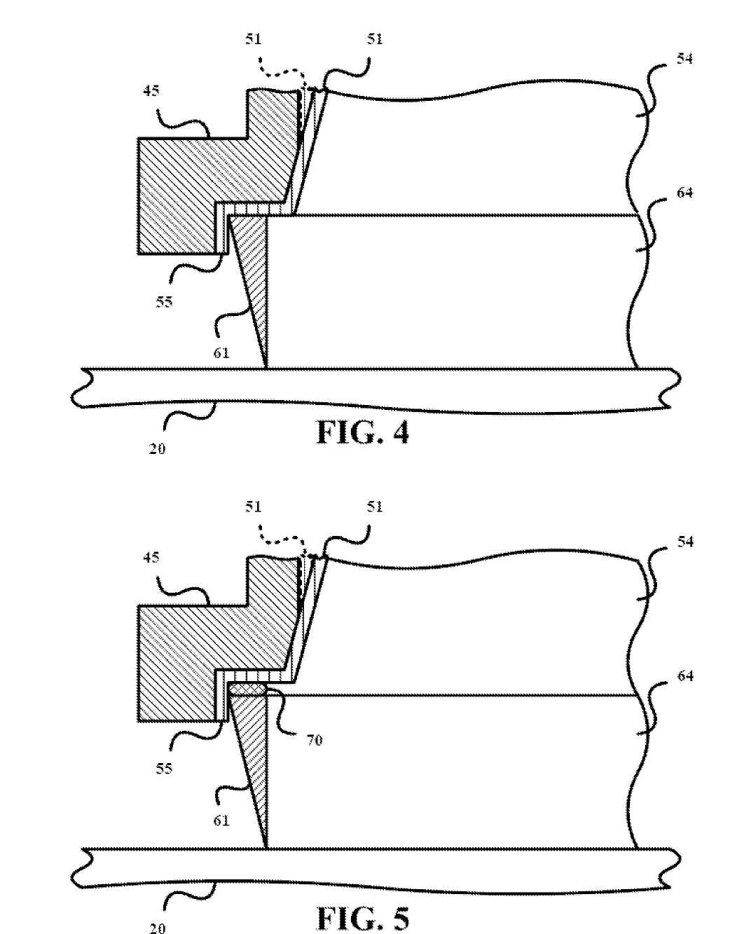

In second sealing configuration embodiment, as shown in FIG. 5, the flange of open outlet 42 (FIG. 2) is again in the form of seat 45 and the flange of open outlet 54 is again in the form of seat 55. As assembled, seat 45 supports seat 55, which in turn supports an O-ring 70 adjacent conduit 64 to thereby physically align liquid reservoir 54 with conduit 64. In this embodiment, O-ring 70 serves as the sole or primary seal as would be appreciated by those having ordinary skill in the art.

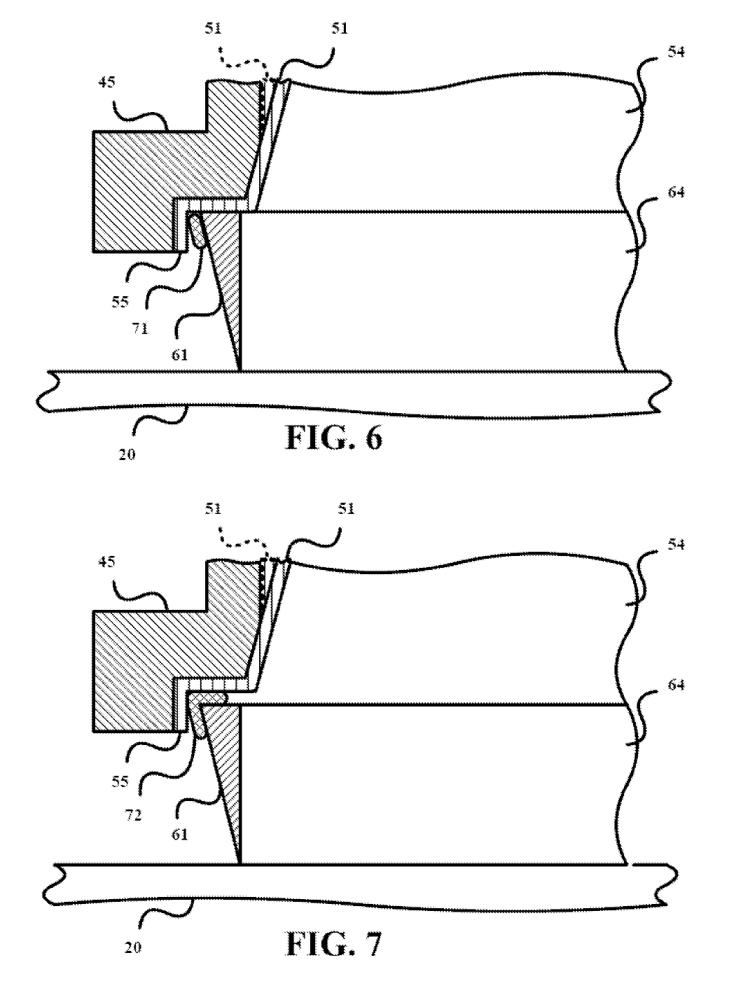

In a third sealing configuration embodiment, as shown in FIG. 6, the flange of open outlet 42 is again in the form of seat 45 and the flange of open outlet 54 is again in the form of seat 55. As assembled, seat 45 supports seat 55, which in turn supports an O-ring 71 adjacent an outer surface of doctor blade 61 to thereby physically align liquid reservoir 54 with conduit 64. In this embodiment, O-ring 71 serves as the sole or primary seal as would be appreciated by those having ordinary skill in the art.

In a fourth sealing configuration embodiment, as shown in FIG. 7, the flange of open outlet 42 (FIG. 2) is again in the form of seat 45 and the flange of open outlet 54 is again in the form of seat 55. As assembled, seat 45 supports seat 55, which in turn supports an O-ring 72 adjacent conduit 64 and the outer surface of doctor blade 61 to thereby physically align liquid reservoir 54 with conduit 64. In this embodiment, O-ring 72 serves as the sole or primary seal as would be appreciated by those having ordinary skill in the art.

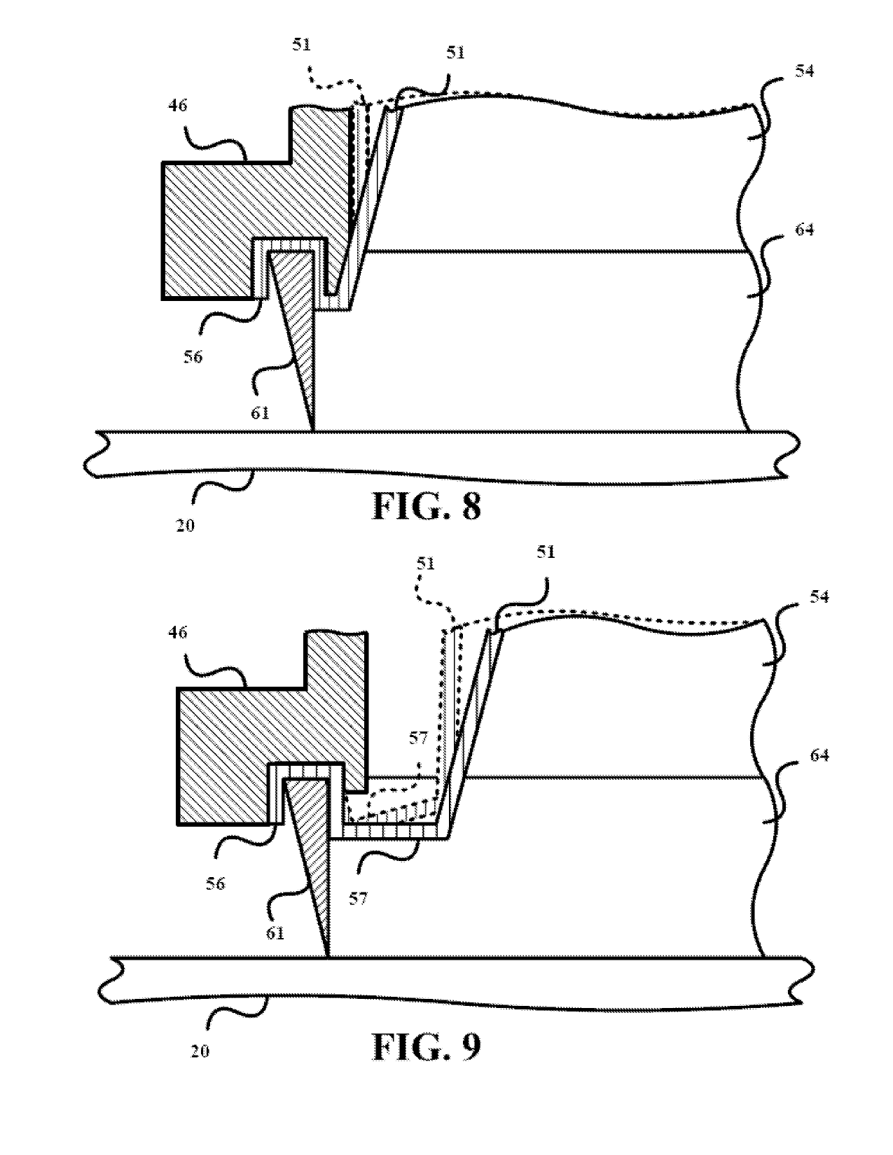

In a fifth sealing configuration embodiment, as shown in FIG. 8, the flange of open outlet 42 (FIG. 2) is in the form of a channeled seat 46 and the flange of open outlet 54 is in the form of a seal 56. As assembled, channeled seat 46 supports seal 56, which in turn encloses conduit 64 of doctor blade 61 to thereby physically align liquid reservoir 54 with conduit 64. In this embodiment, seal 56 serves as the sole or primary seal as would be appreciated by those having ordinary skill in the art.

In a sixth sealing configuration embodiment, as shown in FIG. 9, the flange of open outlet 42 (FIG. 2) is again in the form of channeled seat 46 and the flange of open outlet 54 is in the form of seal 56 and a hinge 57. As assembled, channeled seat 46 supports seal 56, which in turn encloses conduit 64 of doctor blade 61 to thereby physically align liquid reservoir 54 with conduit 64. Hinge 57 has a flexible material composition to facilitate an expansion of liquid reservoir 54 and more importantly, to facilitate a movement of doctor blade 61 relative to disposable cup insert 50 (FIG. 2) due to imperfections in the surface contact between cliché plate 20 and doctor blade 61 and to the pressurized environment within liquid reservoir 54. In this embodiment, seal 56 again serves as the sole or primary seal as would be appreciated by those having ordinary skill in the art.

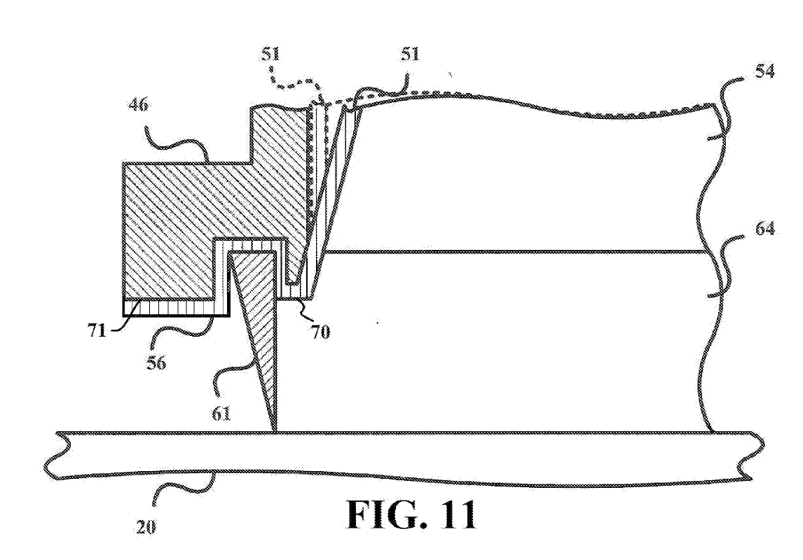

In a seventh sealing configuration embodiment, as shown in FIG. 11, the flange of open outlet 42 is again in the form of channeled seat 46 and the flange of open outlet 54 is in the form of seal 56. In contrast to the fifth sealing configuration, the seventh sealing configuration includes an inner bottom portion 70 of seal 56 substantially collinear with an outer lower portion 71 of channeled seat 46. Additional stability is provided whereby seal 56 extends adjacent outer lower portion 71 of channeled seat 46. As assembled, channeled seat 46 supports seal 56, which in turn encloses conduit 64 of doctor blade 61 to thereby physically align liquid reservoir 54 with conduit 64. In this embodiment, seal 56 serves as the sole or primary seal as would be appreciated by those having ordinary skill in the art. An orientation of the elements in such a fashion allows ink to flow substantially unimpeded to the edge of a scraping element, and allows better ink coverage of the image. In one embodiment, the reservoir body 51 includes an inner bottom portion 70 and an outer lower portion 71 separated by a recessed portion, such that the recessed portion is configured to mate with a conduit body, and the inner bottom portion 70 and an outer lower portion 71 are substantially collinear. In another embodiment, the reservoir body 51 includes an inner bottom portion 70 and an outer lower portion 71 separated by a recessed portion, such that the recessed portion is configured to mate with a conduit body, and the inner bottom portion 70 and an outer lower portion 71 are not substantially collinear. In another embodiment, the channeled seat includes a recessed portion separating an inner portion and an outer portion such that a lower surface of the inner portion is not collinear with a lower surface of the outer portion and each of the inner portion, recessed portion, and outer portion is configured to mate with a reservoir body holding ink.

Referring to FIGS. 4-8 and 11, the previous flange embodiments of open outlet of disposable cup insert 50 can also have a flexible material composition to facilitate an expansion of liquid reservoir 54 as indicated by the dashed outline of reservoir body 54. Furthermore, disposable cup insert 51 may be supported by reusable cup 45 by any other technique as would be appreciated by those having ordinary skill in the art (e.g., friction and snaps).

Referring to FIGS. 1-8, those having ordinary skill in the art will appreciate many advantages of the liquid supply assembly of the present invention, including, but not limited to, a disposable cup insert nesting in a reusable cup to thereby hold liquid away from the reusable cup while permitting the normal use of the reusable cup by a pad printing system. The result is a significant reduction in labor, material and costs associated with a cleaning of the reusable cup.

Furthermore, for the sealing configuration embodiment shown in FIG. 9, those having ordinary skill in the art will appreciate that a suitable compressive engagement between cliché plate 20 and doctor blade 61 can be maintained over the circumference of doctor blade 61 irrespective of imperfections in the surface contact between cliché plate 20 and doctor blade 61 and irrespective of the pressurized environment within liquid reservoir 51 (FIG. 2).

One of skill in the art would appreciate that additional sealing configurations are possible within the scope of the invention as modifications or combinations of the presently illustrated embodiments.

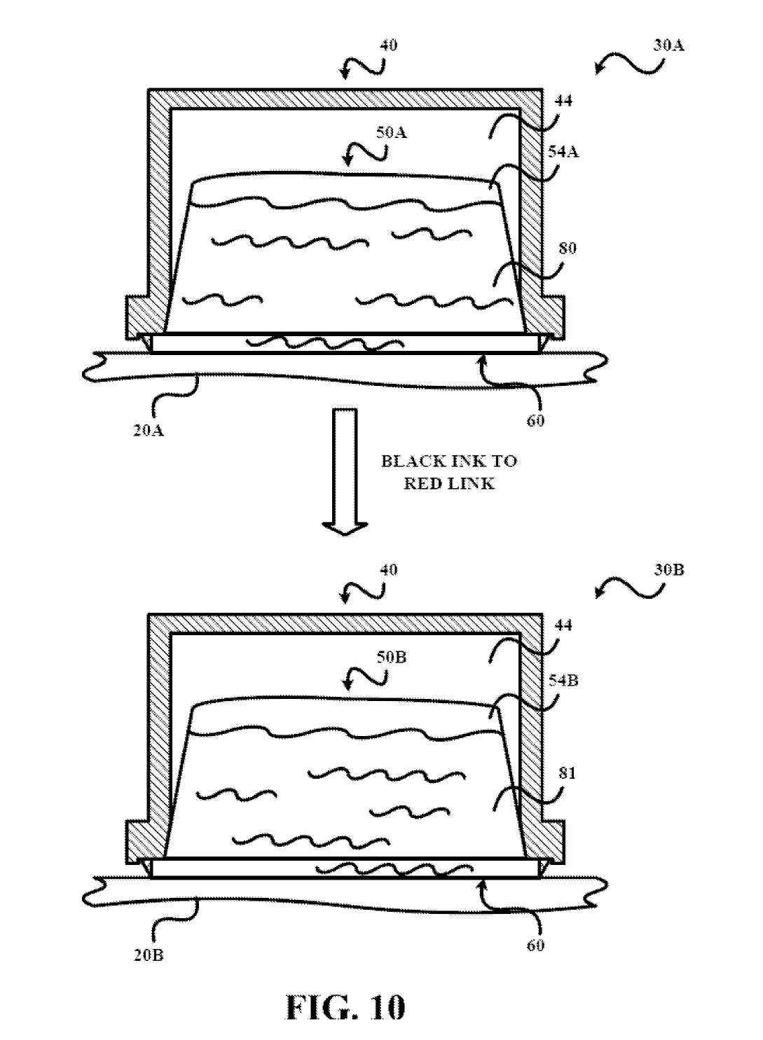

FIG. 10 illustrates a further advantage of the present invention. Specifically, a black liquid supply assembly 30A includes a disposable cup insert 50A inserted into reusable liquid reservoir 44 of reusable cup 40 with its temporary liquid reservoir 54A holding a black ink/thinner liquid mixture 80 within reusable liquid reservoir 44. As such, black ink held by temporary liquid reservoir 54A can be deposited in a receiving region of cliché plate 20A and any excess of the black ink in the receiving region can be scraped from cliché plate 20A by doctor blade 60.

Upon a conclusion of a printing use of the black ink deposited in the receiving region of cliché plate 20A, another batch of the black ink/thinner liquid mixture 80 can be held by temporary liquid reservoir 54A within reusable liquid reservoir 44 for purposes of depositing more black ink in the receiving region of cliché plate 20A to thereby use the new batch of black ink in another printing process. Alternatively, black liquid supply assembly 30A can be disassembled with a removal of disposable cup insert 50A from reusable liquid reservoir 44, and a red liquid supply assembly 30B can be assembled with a disposable cup insert 50B being inserted into reusable liquid reservoir 44 of reusable cup 40 with its temporary liquid reservoir 54B holding a red ink/thinner liquid mixture 81 within reusable liquid reservoir 44. As such, red ink held by temporary liquid reservoir 54B can be deposited in a receiving region of cliché plate 20B and any excess of the red ink in the receiving region can be scraped from cliché plate 20B by doctor blade 60.

Upon a conclusion of a printing use of the red ink deposited in the receiving region of cliché plate 20B, another batch of the red ink/thinner liquid mixture 81 can be held by temporary liquid reservoir 54B within reusable liquid reservoir 44 for purposes of depositing more red ink in the receiving region of cliché plate 20B to thereby use the new batch of red ink in another printing process. Alternatively, red liquid supply assembly 30B can be disassembled with a removal of disposable cup insert 50B from reusable liquid reservoir 44, and another liquid supply assembly can be assembled with reusable cup 40 as taught herein.

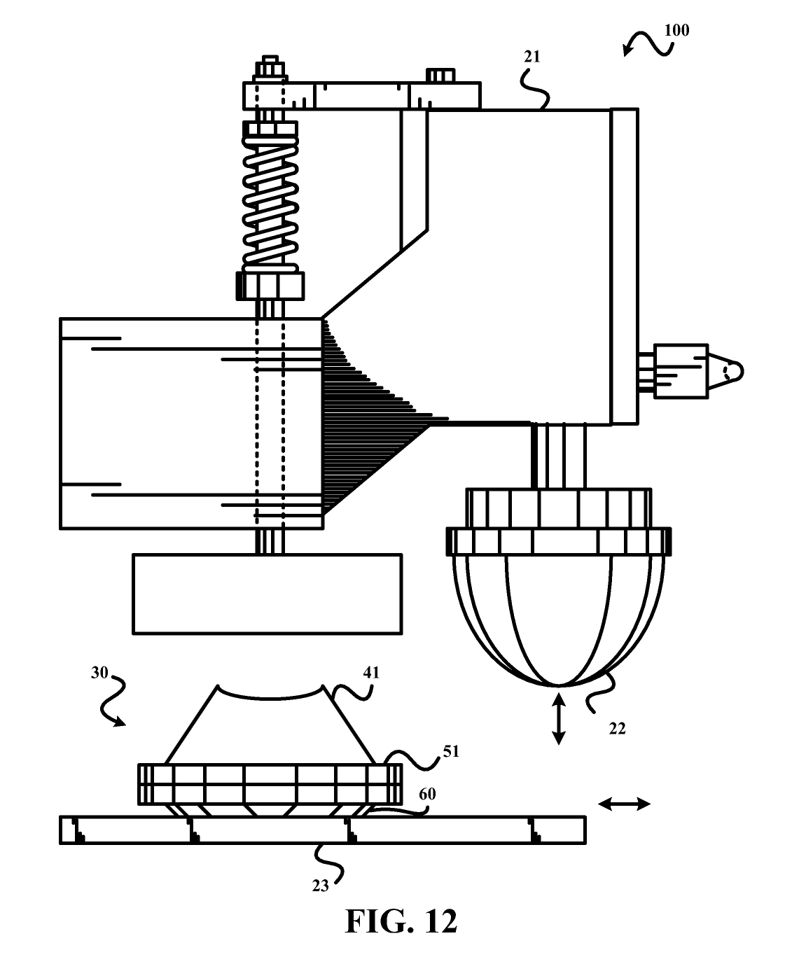

FIG. 12 illustrates a portion of a pad printer 100 including a frame having a reciprocating printing pad 22 mounted thereto, in accordance with one aspect of the invention. Printing pad 22 is a deformable pad onto which ink is transferred, and from which the ink is further transferred to the object to be imprinted. A typical printing pad 22 is formed from a resilient, low permeability material such as silicone rubber or the like.

Also shown are a cliché plate 23, which has the artwork in the form of an engraving or etching, and a liquid supply assembly 30, whereby cliché plate 23 and liquid supply assembly 30 can be reciprocated relative to one another to supply a liquid held by the liquid supply assembly 30 to cliché plate 23 (e.g., ink from an ink/thinner liquid mixture). To this end, liquid supply assembly 30 includes an ink cup liner 41, and a scraping element in the form of a doctor blade 60. In operation, ink cup liner 41 is secured to the doctor blade 60 with ink liner frame 51 as the liquid supply assembly 30 and/or cliché plate 23 are translated in a horizontal direction and liquid held by ink cup liner 41 can be deposited in a receiving region on cliché plate 23 and any excess of the liquid can be scraped from cliché plate 23 by doctor blade 60 to thereby leave liquid in the receiving region only of cliché plate 23. FIG. 12 is similar to the system illustrated in FIG. 1, with the reusable cup removed, and replaced with ink liner frame 51.

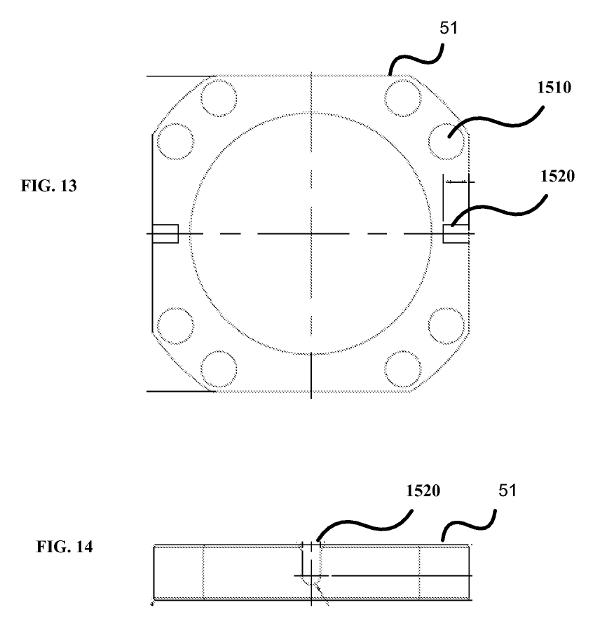

One embodiment of an ink liner frame 51 is illustrated in a top view in FIG. 13, in accordance with one aspect of the invention. Ink liner frame 51 includes at least one magnet 1510 configured to define a magnetic field affecting the doctor blade (such as doctor blade 60 in FIG. 12). Thus, in use, the magnetic ink liner frame is attracted magnetically to the cliché plate. Additionally, magnetic ink liner frame 51 includes slots 1520 to interface with the ink liner to position the ink liner relative to the printing machine and to provide the interface between the printing machine and the ink liner frame 51 for position control. The magnetic ink liner frame 51 is illustrated in side view in FIG. 14, in accordance with one aspect of the invention. In magnetically attached embodiments, the cliché plate is beneficially comprised of a metallic substance to interact with the magnetic field. In one embodiment, the ink liner frame 51 includes two opposing slots 1520 situated on opposing sides of the ink liner frame 51, such as is illustrated in FIG. 13. In one embodiment, eight magnets 1510 are used, although any number of magnets can be used. In one embodiment, four pairs of two magnets are used in an ink liner frame that comprises a substantially polygonal outer edge with a substantially circular inner diameter wherein the four pairs of magnets are disposed near a radiused corner of the ink liner frame.

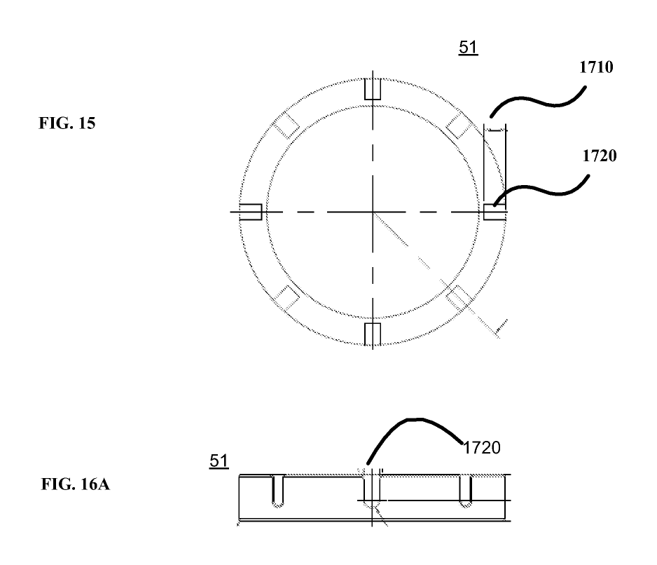

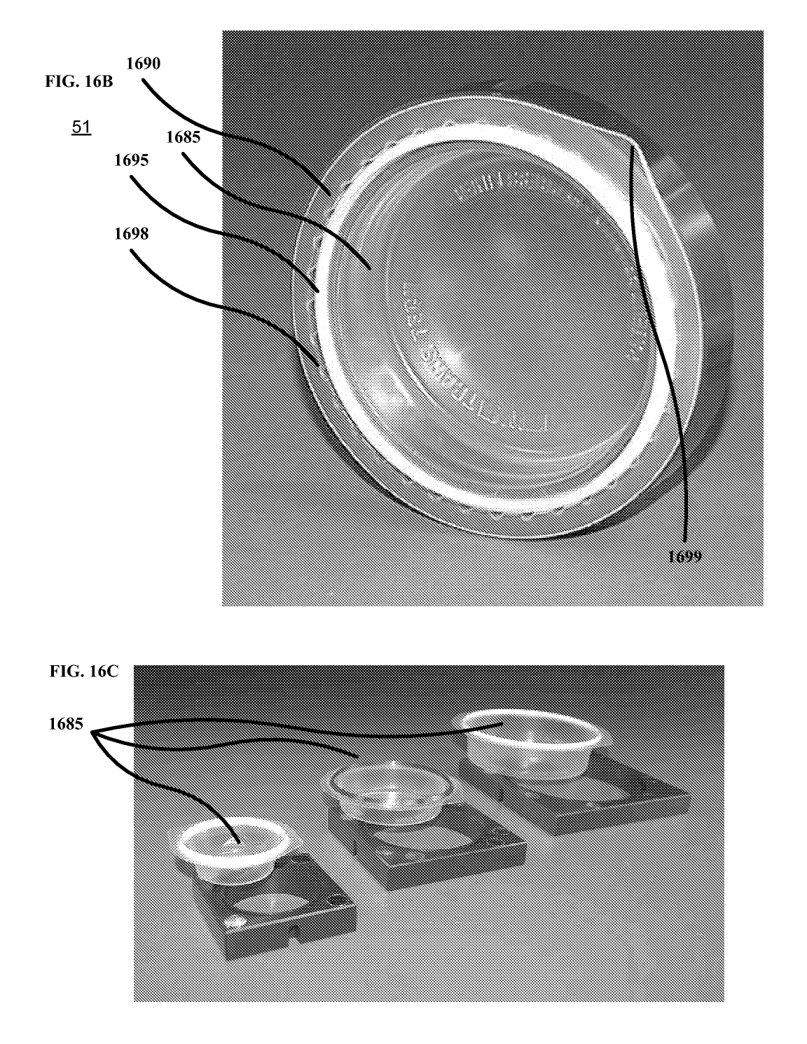

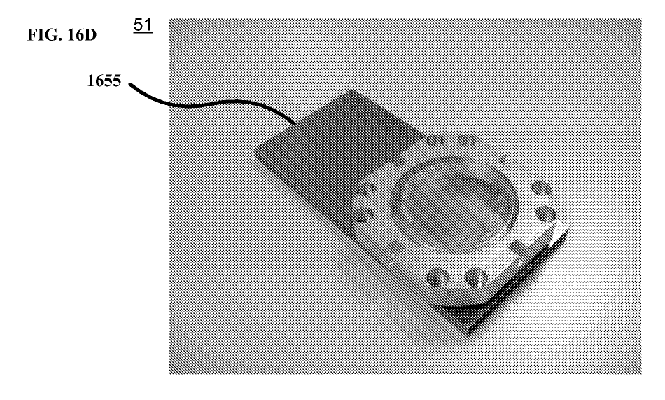

Another embodiment of an ink liner frame 51 is illustrated in a top view in FIG. 15, and a side view in FIG. 16A, in accordance with one aspect of the invention. Ink liner frame 51 includes at least one slot 1710 configured to receive a locking device to mechanically affix the doctor blade to the ink liner frame 51. In one embodiment, the doctor blade includes at least one tongue configured to mate with slots 1710. For example, a latching device can mechanically attach the doctor blade to the ink liner frame to secure the ink liner in position. Additionally, mechanical ink liner frame 51 includes slots 1720 to interface with the pad printing device to position the ink liner relative to the pad printing device. The mechanical ink liner frame 51 is illustrated in side view in FIG. 16A, in accordance with one aspect of the invention. In another embodiment, the doctor blade rotates freely relative to the ink liner frame.

FIG. 16B illustrates a perspective view of an ink liner frame 51 with an ink liner 1685 positioned in the ink liner frame 1690 with a doctor blade 1695 positioned in the ink liner in accordance with one aspect of the invention. As seen in FIG. 16B, each ink liner 1685 includes a lip 1698 extending over the circumference of the ink liner frame 51 and the doctor blade 1695 is inserted into a groove (not seen in FIG. 16B) of the ink liner frame 51. FIG. 16C illustrates a perspective view of a plurality of ink liner frames 51 with the ink liners 1685 slightly disengaged from the ink liner frames 51. FIG. 16D illustrates a perspective view of an ink liner frame with an ink liner disposed within the ink liner frame and disposed upon a cliché plate 1655. In one embodiment, such as illustrated in FIG. 16B, the ink liner lip 1698 includes a protrusion 1699 that extends over the radial thickness of the ink liner frame, such as to provide easier grip for an operator.

In another embodiment, doctor blade 60 rests in a channel formed in liner 41, which then rests into a channel machined or formed into the frame supporting the ink delivery device. In such an embodiment, the ink liner and doctor blade translate together relative to the cliché device, and are held in position relative each other with frictional forces. Such an embodiment is illustrated in FIGS. 16B and 16C.

In one embodiment, the ink liner frame defines an ink liner frame height as well as an ink liner frame diameter. In one embodiment, the ink liner frame height is less than the ink liner frame diameter. In one embodiment, the ink liner frame is substantially circular. In one embodiment, the ink liner is at least partially translucent so that an operator can observe ink volumes within the ink liner during operation. In one embodiment, the ink liner frame includes a substantially polygonal outer edge and a substantially circular inner diameter. In another example, the outer edge of the ink liner frame is substantially circular and the inner edge of the ink liner frame is substantially circular. In other embodiments, the inner edge of the ink liner frame is at least partially polygonal, and shaped to mate with a partially polygonal ink liner. In one embodiment, the ink liner frame includes at least one counter sink configured to mate with physical features of an ink liner.

In one embodiment, a new ink liner is received near the pad printer, filled with ink and/or solvent. A seal is removed from the ink liner to expose the ink to the air, preferably with the open end in a position to reduce spillage. In one embodiment, the doctor blade is inverted and attached to the ink liner with an ink liner frame, either magnetically or mechanically depending on embodiment. In another embodiment, the ink liner is placed into the ink liner frame, and the doctor blade is inserted into a groove on the ink liner. This ink dispensing system, including the ink liner, ink liner frame, and doctor blade is then inverted and placed within the pad printing system.

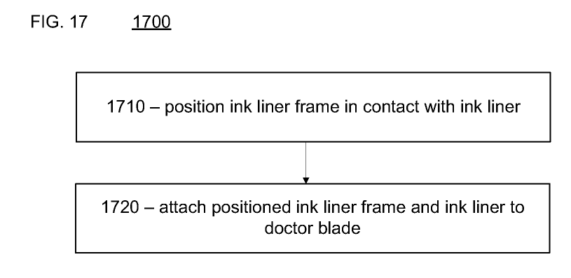

FIG. 17 is a flowchart illustrative of a method 1700 for operating a pad printing system, in accordance with one aspect of the invention. Method 1700 includes positioning an ink liner frame in contact with an ink liner at step 1710. The ink liner frame is placed in an appropriate position to removably attach the ink liner to a doctor blade. The positioned ink liner frame and ink liner are then attached to a doctor blade at step 1720.

The ink liner is then, in one embodiment, fastened to the doctor blade. The ink liner can be fastened mechanically or magnetically, or a combination of both mechanically and magnetically.

All patents referred to herein, are incorporated herein by reference, whether or not specifically done so within the text of this disclosure.

In the disclosure, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims

1. A pad printing system, comprising:
a doctor blade; and
an ink liner frame removably attached to the doctor blade; wherein the ink liner frame is removably attachable to an ink liner.

2. The system of claim 1 further comprising an ink liner removably attached to the ink liner frame.

3. The system of claim 1 wherein the ink liner frame includes at least one slot and wherein the doctor blade includes a tongue configured to mate with the slot.

4. The system of claim 1 wherein the ink liner frame includes at least one magnet, the magnet defining a magnetic field, wherein the magnetic field affects the doctor blade.

5. The system of claim 1 wherein the ink liner frame defines an ink liner frame height and an ink liner frame diameter, and wherein the ink liner frame height is less than the ink liner frame diameter.

6. The system of claim 1 wherein the ink liner frame is substantially circular.

7. The system of claim 1 wherein the doctor blade includes at least one metallic attachment portion and the ink liner frame comprises at least one ink liner frame attachment portion comprising at least one magnet.

8. The system of claim 1 wherein the doctor blade mechanically attaches to the ink liner frame to position an ink liner.

9. A method of operating a pad printing system, the method comprising:
positioning an ink liner frame in contact with an ink liner; and
attaching the positioned ink liner frame and ink liner to a doctor blade.

10. The method of claim 9 further comprising:
fastening the ink liner to the doctor blade.

11. The method of claim 10 wherein fastening the ink liner to the doctor blade comprises:
magnetically securing the liner ring to the doctor blade.

12. The method of claim 10 wherein fastening the ink liner to the doctor blade comprises:
mechanically securing the liner ring to the doctor blade.

13. A pad printing system, comprising:
a doctor blade;
an ink liner; and
an ink liner frame removably attached to the doctor blade; wherein the ink liner frame is removably attachable to the ink liner.

14. An ink liner positioning device comprising:
an ink liner frame defining an ink liner frame height and an ink liner frame diameter, wherein the ink liner frame height is less than the ink liner frame diameter, the ink liner frame comprising a doctor blade attachment portion and an inner diameter.

15. The device of claim 14 wherein the inner diameter is configured to position an ink liner relative to the doctor blade attachment portion.

16. The device of claim 15 wherein the doctor blade attachment portion is configured to attach to a doctor blade.

17. The device of claim 16 wherein the doctor blade attachment portion comprises at least one magnet.

18. The device of claim 16 wherein the doctor blade attachment portion comprises at least one slot.
